(19) United States
(12) Patent Application Publication
(10) Pub. No.: US 2017/0150741 A1
(43) Pub. Date: Jun. 1, 2017

(54) METHOD FOR PRODUCING A PREDOMINANTLY MEAT-BASED ANIMAL FEED PRODUCT AND CORRESPONDING ANIMAL FEED PRODUCT FOR CARNIVOROUS ANIMALS

(71) Applicant: Hans-Juergen DEUERER, Bretten (DE)

(72) Inventor: Hans-Juergen DEUERER, Bretten (DE)

(21) Appl. No.: 15/310,125

(22) PCT Filed: May 19, 2015
(86) PCT No.: PCT/EP2015/060977

§ 371 Date: Nov. 10, 2016

(30) Foreign Application Priority Data
May 19, 2014 (DE) 10 2014 107 058.5

(51) Int. Cl. A23K 50/45; A23K 10/30; A23K 10/35; A23K 50/42; A23K 20/158; A23K 20/163; A23K 40/00; A23K 40/25; A23K 10/20; A23K 20/10

(52) U.S. Cl. CPC A23K 50/45; A23K 10/20; A23K 10/30; A23K 10/35; A23K 20/10; A23K 20/158; A23K 20/163; A23K 40/00; A23K 40/25; A23K 50/42

(57) ABSTRACT

The invention relates to a method for producing a predominantly meat-based animal feed product. The invention also relates to a predominately meat-based animal feed product which can be obtained according to the claimed method, to the use of the claimed predominately meat-based animal product as food for carnivorous animals.

The invention relates to a method for producing a predominantly meat-based animal feed product. The invention further relates to a predominantly meat-based animal feed product obtainable by the method according to the invention and to the use of the predominantly meat-based animal feed product according to the invention as feed for carnivorous animals.

Carnivorous animals such as dogs and cats, which are kept as pets, are often not fed a species-appropriate diet.

In nature, these animal species chiefly feed on prey, i.e., they consume animal proteins in the form of meat.

In preparing feed products for carnivorous animals, it is nutritionally appropriate to provide a high protein content with a simultaneously low carbohydrate content.

In addition to the principal feed given as a main meal in the form of dry, semi-moist, or moist feed, there is increasing consumer demand for snacks-such as drops that are to be used for special functions such as dental care or for raising and training purposes.

The bite-sized animal feed for dogs or for rodents known in the prior as drops consists almost exclusively of cereal, vegetables, and oils and fats-for example, “Drops Cheese Flavor,” and only in the case of variety sold for dogs, “Drops Liver Sausage Flavor”—and has a low content of meat and animal byproducts.

Carnivorous animals not fed a species-appropriate diet have problems such as increased susceptibility to metabolic diseases. There is therefore a need to provide a nutritionally suitable feed that is well-accepted by carnivorous animals in various feed shapes.

The object is achieved by a method for producing a predominantly meat-based animal feed product wherein
a. a cutter for producing an animal feed precursor is charged with at least the following ingredients, which have a temperature equal to or lower than +25° C.: at least one component of the meat group,
b. the ingredients are minced to form a feed precursor with a moisture content of 30 wt % to 60 wt %,
c. optionally, the feed precursor is shaped, optionally by extrusion,
d. optionally, the optionally shaped feed precursor is dried until a moisture content of 5 wt % to 40 wt % is reached,
e. the optionally dried feed precursor is crushed into particles 0.5 mm to 8 mm in size,
f. the particles of the optionally dried feed precursor are conched into an animal feed mass, optionally with one or a plurality of components of the group cheese, milk powder, cream powder, liver sausage and/or fat, and
g. the animal feed mass is shaped into a predominantly meat-based animal feed product and optionally cooled to a temperature of between 1° C. and 25° C.

By means of the method according to the invention, an animal feed product is provided that is characterized by being particularly well-accepted by carnivorous pets. Surprisingly, it was found that the method according to the invention leads to a particularly soft texture of the predominantly meat-based animal feed product.

A predominantly meat-based animal feed product is understood to be an animal feed product that contains at least 20 wt % of meat relative to the total weight of the feed precursor or the animal feed product.

“Meat” is understood to refer to all meat parts of slaughtered warm-blooded land animals, fresh or preserved by a suitable method, and all products of processing of the bodies of land animals that are allowed in animal feed processing.

In an advantageous embodiment, the meat content of the feed precursor or the animal feed product is between 30 wt % and 95 wt %, preferably between 40 wt % and 80 wt %, and more preferably between 60 wt % and 70 wt %. This embodiment is advantageous in that the predominantly meat-based animal feed product is consumed by animals particularly readily, wherein acceptance further increases with increasing meat content.

In an advantageous embodiment, the ingredients for producing the feed precursor have a temperature in the range of −18° C. to +7° C. This embodiment is advantageous in that the mincing time required until the protein contained in the precursor disintegrates (i.e. the proteins are denatured by destruction of the cell membranes) and a bonded feed precursor is produced is only approximately 5 to 15 minutes, e.g. approximately 5 to 10 minutes. Accordingly, the method is particularly economical with respect to the required expenditure of time and energy. By means of mincing, this embodiment provides an animal feed precursor whose temperature is up to approximately 15° C. By using the cutter for crushing the meat, the cell structures such as the cell membranes are ruptured and proteins are denatured. Disintegration occurs that is similar to the disintegration of protein.

In an advantageous embodiment, additional cooling is carried out, for example by adding ice or cooling the cutter by means of cooling elements, so that a maximum temperature of approximately 5° C. is reached. At a maximum temperature of the produced feed precursor of approximately 5° C., the texture of said processor is particularly homogenous.

“Cutter” and “minting” are understood in the present invention to mean that the components contained in the cutter are finely and minutely crushed. This means that the particle size distribution is in the range of 10 mm to 0.1 mm or smaller. Mincing is characterized by a process in which the cell membranes of as many cells as possible are damaged so as to obtain a fine, homogeneous mass. The term “cutter” is known to the person skilled in the art. In this process, the blades are used at a speed of at least 60 rpm, for example at least 200 rpm, e.g. at least 2860 rpm. This causes at least partial denaturing of the proteins during mincing.

Conching is understood here to refer to mixing, drying, kneading, and shearing, as well as liquefaction of the mass. Conching is a mixing process specially developed by the chocolate industry in order to achieve a particular melt and homogeneity of the product. It therefore goes beyond simple stirring. In conching, a circular conching machine is used that has a rotating conical funnel in the container. By means of corresponding mixing vanes, the desired final product quality can be achieved with a mixing duration of 3-30 minutes and a temperature of 15° C. to 50° C.

The moisture content of the feed precursor can advantageously be between 40 wt % and 50 wt %. The advantage of using a feed precursor with this moisture content of 40 wt % to 50 wt % is that—if drying is necessary—the drying step can be kept short, so that the nutrients in the predominantly meat-based animal feed can be retained to the greatest extent possible.

In a further advantageous embodiment, drying of the optionally shaped feed precursor until a moisture content of 5 wt % to 40 wt % is reached is advantageously carried out at a temperature in the range of 50° C. to 200° C. In the temperature range of 50° C. to 200° C., there is a favorable relationship between the time required to reach a moisture content of 5 wt % to 40 wt % and the energy required for drying.

Drying of the optionally shaped feed precursor until a moisture content of 5 wt % to 40 wt % is reached can also advantageously be carried out in a temperature range of 80° C. to 90° C. Surprisingly, it was found that in this temperature range, the relationship between economically advantageous drying and the nutrient content of the predominantly meat-based animal feed product according to the invention is the most favorable.

For example, the optionally shaped feed precursor can be dried to a moisture content of approximately 10 wt % to 25 wt %, and particularly approximately 12 wt %. The subsequent grinding process in the method according to the invention provides a particularly homogenous grinding result with a moisture content of the optionally shaped feed precursor of approximately 12 wt %.

If shaping is carried out, this can take place by extrusion—i.e. by a thermal process in which the components of the product are decomposed by sudden evaporation of the water contained in the product and are given a certain shape by simultaneously pressing them through a nozzle.

In principle, shaping of the feed precursor can also be carried out by non-thermal means, in which case the feed precursor should then pass through a steam tunnel.

In a further advantageous embodiment, conching is carried out with one or a plurality of components of the group cheese, milk powder, cream powder, liver sausage, and/or fat. Advantageously, different flavors of the predominantly meat-based animal feed product, including species-specific flavors, can be produced, such as liver sausage flavor, poultry flavor, cheese flavor, etc.

In an embodiment, the optionally dried feed precursor is added to the conching machine in the form of particles together with the further components, except for the fat. This mixture is blended until the temperature is the range of 20° C. to 60° , for example in the range of 25° C. to 40° C., e.g. approx. 30° C. After this, the fat, e.g. liquid fat such as liquid palm fat, is added. The conching is continued for at least 10 minutes, for example. Conching is continued, for example, until the mass reaches a temperature of 30° C. to 60° C., e.g. is in a range of 38° C. to 42° C.

In a further advantageous embodiment, after conching, the predominantly meat-based animal feed product can be shaped by means of a roller former. Surprisingly, this type of shaping made it possible to achieve further improvement in the degree of acceptance of the feed product.

In a further advantageous embodiment, the ingredients for producing the feed precursor are used in completely or partially frozen form. Surprisingly, it was found in this case that such a feed precursor requires only particularly brief conching times in the further course of the method and is therefore highly economical.

In a further advantageous embodiment, the ingredients for producing the feed precursor are crushed before charging of the cutter by feeding them through one or a plurality of perforated disks. It has been found in this case that crushing before the mincing process provides a more homogenous feed precursor, and as a result, the mincing process does not have to be excessively prolonged, so that the animal proteins are retained as favorably as possible.

In a further advantageous embodiment, vegetables and/or cereal and/or potatoes and/or glycerol are added to the ingredients for producing the feed precursor before mincing. These further feed components provide better technical processing of the feed, in the sense that the feed precursor is easier to process because it is less tacky. Surprisingly, it was found that the tackiness of the feed precursor can be reduced by adding the above-mentioned further feed components to the ingredients for producing the feed precursor before the mincing process.

In a further advantageous embodiment, additives commonly used in the animal feed industry are added in conching. In particular, these are flavoring agents, natural or synthetic dyes, inactivated yeasts or yeast extracts, plant extracts and/or concentrates, preservatives, sugars, and/or functional ingredients. Functional ingredients are understood, for example, to be probiotics, but also vitamins, minerals, omega-3 fatty acids, probiotic dietary fiber, and probiotic microorganisms. If fat is added in conching, the above-mentioned additives—if they are to be added-are added before said fat.

Preservatives such as potassium sorbate can be used in the method. For example, potassium sorbate can be used in a concentration of 0.1 wt % to 1 wt % relative to the total weight of the feed precursor. Addition of potassium sorbate in an amount of approximately 0.5 wt % relative to the total weight of the feed precursor results in a minimum shelf life of the predominantly meat-based animal feed product according to the invention of approximately 15 to 18 months.

Advantageously, there is no need to use binders such as carrageenan, gelatin, agar agar or pectin. Nor do dairy products or their proteins need to be used. This is advantageous with respect to possible intolerance to dairy products or milk protein.

The predominantly meat-based animal feed product according to the invention is obtainable by the method according to the invention.

In an advantageous embodiment, the predominantly meat-based animal feed product produced according to the invention has a compressive strength of between 235 kPa and 309 kPa, and particularly approximately 271 kPa. This compressive strength results from the particularly soft texture, which leads to corresponding haptics.

In order to test compressive strength, the force required to press a cylinder 20 mm in diameter into the sample was determined, wherein the deformation of the sample to be tested was 50% of the sample height. The compressive strength of the sample was determined from the measured maximum force and the impinging cylinder area, wherein only samples with a diameter greater than 15 mm were measured. Measurement was carried out at 20° C. and a relative humidity of 55%. The test piece was in the form of drops with a diameter of approx. 20 mm and a height of 10 to 14 mm.

The meat-based animal feed product according to the present invention advantageously has a fat content of between 5 wt % and 70 wt %, a protein content of between 10 wt % and 50 wt %, an ash content of between 2 wt % and 20 wt %, and a pH of between 5 and 6.5. The effect of this composition is that such a predominantly meat-based animal feed product provides particularly favorable nutrition for carnivorous animals.

In an advantageous embodiment, the predominantly meat-based animal feed product according to the invention has a moisture content of between 2 wt % and 35 wt %, preferably between 4 wt % and 10 wt % (dry animal feed product), or 15 wt % to 30 wt % (semi-moist animal feed product). The advantage of such a dry or semi-moist animal feed product is that it is readily accepted by the animals for which the predominantly meat-based animal feed product is intended, and allows particularly practical handling by the people feeding the animals. In particular, predominantly meat-based animal feed products according to the invention with a moisture content of approximately 12 wt % have a particularly well-accepted texture.

The predominantly meat-based animal feed product according to the invention can be present or produced in the form of pieces.

In a further advantageous embodiment, the predominantly meat-based animal feed product according to the invention is shaped into bite-sized form. Surprisingly, it was found that the particular “softness” of the predominantly meat-based animal feed product according to the invention is particularly conducive to a bite-sized feed shape. In particular, the bite-sized feed shape can be in the form of the drops known in prior art, e.g. similar to a drop that is actually flat on one side. Other shapes, such as stars, hearts, etc., are also advantageous, as they are particularly well-accepted by animal owners at certain times throughout the year.

In a further advantageous embodiment, the predominantly meat-based animal feed product is sealed in a foil package, particularly a tubular bag package, a stand-up pouch, a hollow shell package, or a can. This embodiment is advantageous in that the moisture content that is required by process engineering and determines the texture of the predominantly meat-based animal feed product is achieved for longer than the intended minimum shelf life of the product.

With the method described above, a new predominantly meat based animal feed product is obtained that consists exclusively of meat, for example dried meat-optionally ground into meal—to at least 20 wt %, preferably between 30 wt % and 95 wt %, and more preferably between 40 wt % and 80 wt %, for example between 60 wt % and 70 wt % relative to the total weight of the feed precursor or the meat-based animal feed product.

The predominantly meat-based animal feed product according to the invention can be dyed in one or multiple colors with natural dyes. It has been shown that this measure makes the product even more acceptable to the animal owner.

The predominantly meat-based animal feed product according to the invention can also be combined with other feed products in sales units or offered for sale as mixed animal feed. It can advantageously be sold as cat food, dog food, or feed for other carnivorous pets in the form of complete animal feed or snacks.

In the following, the invention is described in further detail with respect to an illustrative embodiment that serves only to explain a possible embodiment and by no means limits the scope of the invention.

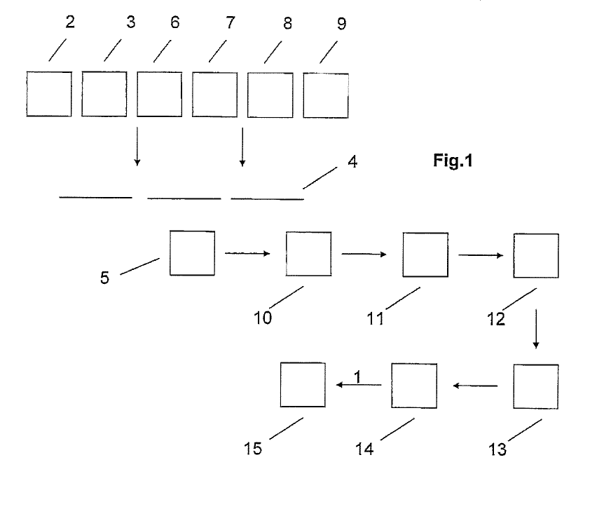

FIG. 1, which is the only figure, shows a schematic diagram of the production of a predominantly meat-based animal feed product according to the invention. First, the ingredients of the group “meat” are placed in the cutter 5. These ingredients are located in containers 2 and optionally 3 (if separate containers, e.g. for meat of different animal species, are provided) and are conveyed from there to the cutter 5. There are also further containers for vegetables 6 or cereal 7 or potatoes 8 or glycerol 9, which can be added to the meat-based ingredients. 4 denotes perforated disks that are upstream from the cutter 5 and are used to crush at least the meat-based ingredients for producing the feed precursor. After mincing in the cutter 5, the feed precursor is conveyed to an extruder 10 for extrusion. From the extruder 10, the shaped feed precursor is fed into a dryer, denoted by 11. A mill 12 is connected thereto, which for example grinds the extruded dried strands of the feed precursor into particles having an average size von 0.5 mm to 8 mm. For example, the particulate dried feed precursor is introduced via a tube into a conching machine 13, wherein further containers are provided, for example for cheese and liver sausage, the contents of which can be supplied via feed lines to the conching machine 13 (the further containers and their feed lines are not shown in FIG. 1). A further feed line is provided for the feeding of fat (also not shown in FIG. 1). A second extruder 14 connected to the conching machine 13 can also be provided. By means of corresponding nozzles, it is possible to produce a shaped, predominantly meat-based animal feed product according to the inventions 1—e.g. as drops, hearts, or stars. The size of the predominantly meat-based animal feed product 1 is selected so that it can be optimally consumed by the respective carnivorous animal species; for example, the diameter is approximately 1 cm for cat drops, while it can be approximately to 4 cm for dogs. After leaving the extruder, the final product, i.e. the predominantly meat-based animal feed product 1, is sent on to processing and/or packaging units, denoted here collectively by 15.

1. A method for producing a predominantly meat-based animal feed product with a content of at least 20 wt % meat relative to the total weight of the animal feed product, comprising the steps of:
a) charging a cutter (5) for producing an animal feed precursor with ingredients comprising at least one meat having a temperature equal to or lower than +25° C.,
b) mincing the ingredients to form a feed precursor with a moisture content of 30 wt % to 60 wt %,
c) optionally, drying the feed precursor until a moisture content of 5 wt % to 40 wt % is reached,
d) shaping the optionally dried feed precursor into particles between 0.5 mm and 8 mm in size,
e) conching the particles of the optionally dried feed precursor into an animal feed mass, optionally with one or a plurality of components selected from the group consisting of cheese, milk powder, cream powder, liver sausage, and fat, and
f) shaping the animal feed mass into a predominantly meat-based animal feed product and optionally cooling said predominantly meat-based animal feed product to a temperature of between 1° C. and 25° C.

2. The method according to claim 1, wherein the feed precursor according to step b) is shaped.

3. The method according to claims 1, wherein the particles in step d) are obtained by crushing of the feed precursor.

4. The method according to claims 1, wherein after conching, the meat-based animal feed product is shaped by means of a roller former.

5. The method according to claim 1 one of the previous claims, characterized in that wherein the ingredients for producing the feed precursor are used in a completely or partially frozen form.

6. The method according to claim 1, wherein at least one of vegetables, cereal, potatoes, and glycerol are added to the ingredients for producing the feed precursor before mincing.

7. The method according to claim 1, wherein if fat is added in conching, before adding said fat, at least one additive selected from the group consisting of flavoring agents, natural or synthetic dyes, inactivated yeast or yeast extracts, plant extracts and/or concentrates, preservatives, sugars, and functional ingredients is added.

8. A predominantly meat-based animal feed product obtainable by a method according to claim 1.

9. The predominantly meat-based animal feed product according to claim 8, wherein said meat-based animal feed product has a compressive strength of between 235 kPa and 309 kPa.

10. The predominantly meat-based animal feed product according to claims 8, wherein said product has a fat content between 5 wt % and 70 wt %, a protein content between 10 wt % and 50 wt %, an ash content of between 2 wt % and 20 wt %, and a pH between 5 and 6.5.

11. The predominantly meat-based animal feed product according to claim 8, wherein said product has a moisture content between 2 wt % and 35 wt %.

12. The predominantly meat-based animal feed product according to claim 8, wherein said product is shaped into pieces.

13. The predominantly meat-based animal feed product according to claim 8, wherein said product is shaped into bite-sized pieces.

14. The predominantly meat-based animal feed product according to claim 8, wherein said product is shaped into drops, stars, or hearts.

15. The predominantly meat-based animal feed product according to claim 8, wherein said product is sealed in a foil package.

16. The predominantly meat-based animal feed product according to claim 8, wherein said product is sealed in a tubular bag package, a stand-up pouch, a hollow shell package, or a can.

17. The method according to claim 2, wherein the feed precursor is shaped by extrusion.
